(19) United States
(12) Patent Application Publication
(10) Pub. No.: US 2023/0297992 A1
(43) Pub. Date: Sep. 21, 2023

(54) METHODS AND SYSTEMS FOR EXTENDING INSTALLMENT OPTIONS

(71) Applicant: MASTERCARD INTERNATIONAL INCORPORATED, Purchase, NY (US)

(72) Inventors: Jerry J. Davis, Wildwood, MO (US); Pablo Cohan, New York, NY (US); Sheryl McKenzie, Wilton, CT (US); Olaseni Alabede, Pleasantville, NY (US); Todd Niemeyer, Chesterfield, MO (US); Lisa Cantos, West Harrison, NY (US)

(21) Appl. No.: 18/119,236

(22) Filed: Mar. 8, 2023

Related U.S. Application Data
(60) Provisional application No. 63/321,622, filed on Mar. 18, 2022.

(51) Int. Cl. G06Q 20/24

(52) U.S. Cl. CPC G06Q 20/24

(57) ABSTRACT

Systems and methods are provided for providing installment options to users for transactions by the users at merchants. One example computer-implemented method includes receiving a request for an installment payment, from a user, via a wallet software development kit (SDK) at a merchant, where the installment payment is for a transaction between the user and the merchant, and then determining eligibility of the merchant for the installment payment based on information in the request and responding to the request with eligible installment types. The method also includes receiving a second request, via an installment SDK at the merchant, for installment options consistent with a selected installment type, determining an installment option for the transaction, and responding to the second request with the installment option. The method then includes, in response to the installment option, creating an installment plan for the installment option and storing the installment plan in memory.

### CROSS-REFERENCE TO RELATED APPLICATION

This application claims the benefit of, and priority to, U.S. Provisional Application No. 63/321,622, filed Mar. 18, 2022. The entire disclosure of the above application is incorporated herein by reference.

### FIELD

The present disclosure generally relates to methods and systems for use in extending installment options to users, and in particular, to methods and systems for use in extending installment options to users to fund purchases for product(s).

### BACKGROUND

This section provides background information related to the present disclosure which is not necessarily prior art.

Users are known to acquire products (e.g., goods and services, etc.) through purchases from merchants. Often, the users fund the purchases through cash, credit, or checks, whereby the users pay full amounts for the purchases and take delivery of the products. When the users pay with credit cards, for example, the users may later make one or more payments to issuers of the credit cards to reimburse the issuers for the full amounts of the purchases (with interest applied according to terms). In addition, it is known for merchants to offer layaway programs to users, whereby the users pay the merchants for the products over a period of time and the products are held by the merchants until all payments are made.

### DRAWINGS

The drawings described herein are for illustrative purposes only of selected embodiments and not all possible implementations, and are not intended to limit the scope of the present disclosure.

FIG. 1 is an example system of the present disclosure operable to provide users with installment options in connection with purchasing products at virtual locations (e.g., of merchants, etc.);

FIG. 2 is a block diagram of an example computing device that may be used in the system of FIG. 1;

FIG. 3 is an example method, which may be used with the system of FIG. 1, for providing a user with installment options at a virtual location of a merchant, for example, in connection with purchase of a product; and

FIGS. 4A-4D illustrate example interfaces that may be presented to a user in the system of FIG. 1 and/or the method of FIG. 3, in connection with a purchase of a product by the user from a virtual merchant location, to thereby provide an installment payment option to the user for use in purchasing the product.

Corresponding reference numerals indicate corresponding parts throughout the several views of the drawings.

### DETAILED DESCRIPTION

Example embodiments will now be described more fully with reference to the accompanying drawings.

Users have a variety of options to fund purchase transactions, including, for example, cash, credit cards, checks, etc. When installment programs are provided to users, terms of the installment programs are typically set by merchants associated with the points of interaction or financial institutions associated with the merchants. In connection therewith, terms of the installment programs are generally take-it-or-leave-it, and are often not as favorable to users as when third party installment providers provide separate installment programs to the users (and compete for business from the users). Alternatively, installment programs may be provided apart from the merchants and the transactions, whereby third party installment providers unrelated to the merchants fund the purchase transactions on behalf of the users and whereupon the users agree to installment terms with the third parties. The lack of integration of such third party installment providers, though, with the merchants involved in the underlying transactions, provides for limited access by such third parties to users requesting the installment payments at the merchants and/or friction in coordinating between users and the third parties in facilitating the installment payments to the merchants, etc.

Uniquely, the systems and methods herein provide for extending installment options to users, for example, from various providers, at virtual merchant locations through which the users may purchase products. In particular, for example, an installment payment provider (IPP) coordinates or offers installment options to users (e.g., via wallet functionality, etc.) in connection with checkout by the users at a merchant, for example, and further coordinates acceptance of the installment options by the users and execution of installment plans consistent with the installment options. In this manner, merchants are provided a centralized coordinator of installment payments with limited integration at e-commerce platforms, for example, while users are extended additional installment options (beyond those offered by the merchants, etc.) and issuers are provided with additional opportunities to fund transactions (e.g., as installment providers, etc.). As such, installment payments are more readily available to users, at appropriate times, while also limiting friction associated with provided identifying information to relevant parties in connection with utilizing installment payment options.

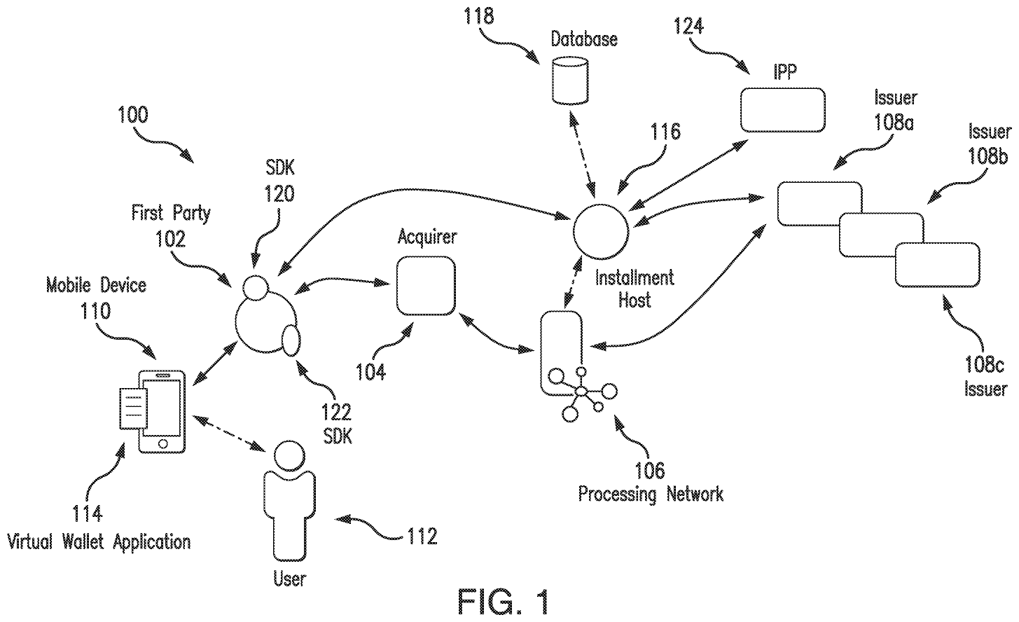

FIG. 1 illustrates an example system 100 in which one or more aspects of the present disclosure may be implemented. Although the system 100 is presented in one arrangement, other embodiments may include systems arranged otherwise depending, for example, on parties included in the system 100, processing of transactions and/or payment options, privacy requirements, etc.

The illustrated system 100 generally includes a first party 102, an acquirer 104 associated with the first party 102, a processing network 106, and multiple issuers 108a-c, each of which is coupled to (and is in communication with) one or more networks (as generally indicated by the arrowed lines in FIG. 1). The one or more networks may each include, without limitation, a local area network (LAN), a wide area network (WAN) (e.g., the Internet, etc.), a mobile network, a virtual network, and/or another suitable public and/or private network capable of supporting communication among two or more of the parts of the system 100 illustrated in FIG. 1, or any combination thereof. For example, one such network may include multiple different networks, such as a private payment transaction network made accessible by the processing network 106 to the acquirer 104 and the issuers 108a-c and, separately, the public Internet, which is accessible as desired to the first party 102, the acquirer 104, the issuers 108a-c, and a user 112 (or specifically, a mobile device 110 associated with the user 112), etc.

The first party 102 in the system 100 is configured to offer for sale and to sell products to consumers including, for example, the user 112. In connection therewith, the first party 102 may include a merchant, etc. What's more, the first party 102 may be disposed and/or accessible at one or more physical locations, such as, for example, at one or more brick-and-mortar locations, and/or at one or more virtual locations, for example, via one or more e-commerce platforms (e.g., a website, network-based application, etc.). In this specific embodiment, the user 112 interacts with the first party 102 through an e-commerce platform. In connection therewith, the user 112 may add one or more products offered for sale by the first party 102 to a virtual shopping cart at the e-commerce platform of the first party 102, and then select an option to checkout to purchase the one or more products, as described in more detail below.

As shown in FIG. 1, the first party 102 (e.g., the e-commerce platform associated therewith, etc.) includes an installment software development kit (SDK) 120 and a wallet SDK 122, both of which are described in more detail below. The installment SDK 120 is associated with and/or provided by an installment host 116, as described below, and the wallet SDK 122 is associated with and/or provided by a wallet provider (e.g., a provider associated with one of the MasterPass®, Apple Pay®, PayPal®, Google Wallet® (Google Pay), Android Wallet™, etc. wallets, or a provider associated with a bank-specific virtual wallet (e.g., CitiPay wallet, etc.), etc.). In one example, the wallet SDK 122 is associated with a secure remote commerce (SCR) platform, such as, for example, Mastercard Click to Pay, etc. It should be appreciated that the installment SDK 120 and the wallet SDK 122 may be included in a single SDK (e.g., the installment SDK 120, the wallet SDK 122, another SDK, etc.), or otherwise included in the e-commerce platform of the first party 102, in other system embodiments.

The acquirer 104 and issuers 108a-c of the system 100 are financial institutions, which commonly issue accounts to various parties. In the context of FIG. 1, for example, the acquirer 104 has issued an account to the first party 102, whereupon funds from the purchase of products by users at the first party 102 (e.g., via payment account transactions, etc.) may be deposited into the first party's account. In connection therewith, various preferences may be associated with the first party 102 during enrollment with the acquirer 104. For example, the first party 102 may identify, as a preference, which types of payment accounts are accepted for payment at the first party 102, etc. It should be appreciated that other preferences related to the first party 102, in connection with the description herein, may be included as part of the enrollment, or otherwise.

The issuers 108a-c are configured to issue payment accounts (e.g., credit accounts, debit accounts, prepaid accounts, etc.) to users, including the user 112. The payment accounts are often linked to payment devices, such as card and/or virtual wallets, etc. For example, as shown in FIG. 1, the user 112 is associated with the mobile device 110, which includes a virtual wallet application 114 (broadly, a network-based application) and which configures the mobile device 110 to communicate with the issuer 108b, for example, to provision a payment account issued by the issuer 108b for the user 112 to the virtual wallet application 114. In this example embodiment, the wallet SDK 122 may be associated with the wallet application 114, whereby a wallet profile of the user 112, associated with the wallet application 114, may be accessible to the user 112 via the wallet SDK 122 (e.g., after a suitable login, authentication, etc.).

In addition, in various embodiments, the issuers 108a-c are configured to participate in an installment service for use in funding installment transactions (e.g., for facilitating installment payments for the transactions, etc.) with merchants, including, for example, the first party 102, in cooperation with users, including, for example, the user 112, etc. (e.g., separate from and/or apart from payment accounts offered by the issuers 108a-c and/or payment accounts the users may have with the issuers 108a-c, etc.). In connection therewith, the users reimburse the issuers 108a-c for the transactions by way of the installment payments over the associated installment period.

The processing network 106 is configured to coordinate transactions between acquirers (e.g., the acquirer 104, etc.), on behalf of payees (e.g., merchants including the first party 102, etc.), and issuers (e.g., the issuer 108c, etc.), on behalf of payers (e.g., the user 112, etc.), etc. The processing network 106 may include, for example, the Mastercard™ processing network, etc. In connection with the above, the processing network 106, in this example embodiment, is associated with (as indicated by the dotted line) the installment host 116, which is configured to manage installment plans from the different issuers 108a-c. In particular in this example embodiment, the installment host 116 is configured to coordinate installment payments, which are based on installment accounts issued from the issuers 108a-c, and funded to the acquirer 104, for example, consistent with the installment plans/options and corresponding installment payments. The installment host 116 is configured to additionally manage installment eligibility on the processing network 106, for example, from or with the acquirer 104 (and other acquirers in the system 100) so that the installment options and payments may be made available to the first party 102 via payment to the acquirer 104, etc. To that end, the installment host 116 is accessible to the various merchants (e.g., first party 102, etc.) and users (e.g., user 112, etc.), as a fifth party in the system 100, to provide payment options for the purchase of one or more products through installment payments, etc. It should be understood that in some embodiments the installment host 116 may be a standalone device separate, or at least partially separate, from the processing network 106. However, in at least one embodiment, the installment host 116 may be integrated, in whole or in part, with one or more of the acquirer 104, the processing network 106, one of the issuers 108a-c, etc. As also shown in FIG. 1, the installment host 116 is associated with an installment database 118, which is illustrated as separate from the installment host 116, but may be included therein, in whole or in part, in various system embodiments, etc.

As further shown in FIG. 1, the system 100 includes an installment payment provider (IPP) 124, which, in this embodiment, is separate from the acquirer 104, the processing network 106, each of the issuers 108a-c, and the installment host 116, etc. The IPP 124 is configured, in general, to manage underwriting of installment plans herein (e.g., as provided by the issuers 108a-c, etc.) and to interact with the user 112 (and other users) in connection therewith (e.g., upon selection of one of such plans by the user 112 (and other users), etc.). This may include, for example, facilitating pre-approval (and actual approval) of the user 112 (and other users) in connection with providing an installment plan to the user 112 and confirming repayment thereof. The installment host 116, then, is configured to provide data integration from the IPP 124 (and, potentially, from other IPPs in the system 100, etc.), including providing an on-behalf-of service, for example, when the IPP 124 does not provide a standard interface to the virtual wallet application 114, etc. It should be appreciated that, while the installment host 116 and IPP 124 are illustrated as separate parts of the system 100 (in FIG. 1), in other embodiments one or more features of the installment host 116 and IPP 124 may be combined or included together in a comment part of the system (e.g., in the installment host 116, in the IPP 124, in another part of the system 100, etc.).

At the outset, the installment host 116 is configured to enroll different acquirers and issuers. For the acquirer 104, for example, the installment host 116 is configured to solicit an agreement from the acquirer 104 and a designation of merchants that have accounts with the acquirer 104 and that opt-in to participate in installment payments. For example, the first party 102 may opt into or out of participating in installment payments (e.g., with the acquirer 104, with the installment host 116, etc.), which may expand the number of users who purchase from the first party 102, but may delay transfers of funds to the first party 102 (consistent with the installment terms), etc. In response, the acquirer 104 is configured to solicit an opt-in parameter or an opt-out parameter (broadly, an installment parameter) from the merchants (e.g., the first party 102, etc.), and to receive an opt-in or opt-out from the merchants. In turn, the acquirer 104 is configured to retrieve data related to each of the opt-in merchants (e.g., a merchant acceptor ID (or MAID), a merchant category code (MCC), etc.) (broadly, installment parameters) (e.g., from memory included in the acquirer 104, or from the installment host 116 and/or processing network 106, via one or more APIs; etc.) and to submit the opt-in or opt-out data (or parameters) of the merchant along with the retrieved merchant data (e.g., the MAID, MCC, etc.), and an acquirer ID associated with the acquirer 104, to the installment host 116 (e.g., via an API associated with the installment host 116, etc.). The installment host 116, in turn, is configured to then update the opt-in or opt-out data (or parameters) associated with the given MAID for the merchant, for example, in the installment database 118. The installment host 116 is configured to repeat the same for various different merchants and/or acquirers, as included in the system embodiment.

For the issuers 108a-c, for example, the installment host 116 is configured to solicit the issuers 108a-c and enroll each with the installment host 116. In this example embodiment, for example, as part of enrollment, the issuers 108a-c are each configured to designate a range of primary account numbers (PANs) (broadly, a parameter) for use in installment payments, whereby an installment payment is identifiable from the PAN included in the installment payment transaction being within the designated range. In addition, similar to the above, the issuers 108a-c are configured to submit eligibility parameters to the installment host 116, including, for example, the account ranges for installment PANs along with plan types, etc. (e.g., via an API associated with the installment host 116, etc.). Furthermore, the issuers 108a-c may be configured to submit pre-approvals for users, specific to certain users (e.g., existing card holders, etc.), etc. as parameters (e.g., for use then by the IPP 124, etc.). For example, the issuer 108a (or one of the other issuers 108b-c) may pre-approve one or more users, including the user 112, for installment options (e.g., where the user 112 may already have an account with the issuer 108a, etc.). In doing so, the issuer 108a may be configured to issue an installment account to the user 112 (e.g., identified by a PAN in a specific range of PANs, etc.). The issuer 108a, then, may be configured to cooperate with a wallet provider (associated with the wallet SDK 122) to provision the pre-approved installment account to the virtual wallet of the user 112. In addition, the issuer 108a (or one of the other issues 108b-c) may be configured to provide rules associated with approval for installment payments, including, for example, specific payment account numbers (or ranges thereof), specific payment account types, specific contact information (e.g., email, mobile phone number, etc.), amount limits, specific MCCs, etc.

Furthermore, the issuers 108a-c are configured to define installment terms for users, more generally. In doing so, the issuers 108a-c may define, for each of the installment options, particular terms and conditions for the installment options, payment terms, interest rates (if applicable), payment timelines, amounts, merchant types/categories, etc. (broadly, installment configurations, etc.). The installment configurations, then, may be used by the issuers 108a-c, for example, to manage business rules governing consumer eligibility for installment options/plans and installment plan processing.

It should be appreciated that the processing network 106 may be configured to retrieve the installment parameters and/or eligibility parameters for the first party 102 and/or user 112 (and/or other first parties and/or users, etc.), for use in handling authorization requests, as described below. What's more, the processing network 106 may be configured with rate and/or fee data related to installment payments, for each acquirer 104 and/or issuer 108a-c, individually or globally, etc. Further, in some embodiments, the installment host 116 and/or the IPP 124 may be configured to retrieve and/or receive the installment parameters and/or eligibility parameters from the acquirer 104 and/or installment host 116, or otherwise, for the first party 102 and/or user 112 (and/or other first parties and/or users, etc.). In doing so, installment host 116 and/or the IPP 124 may use such information to identify merchants that have opted-in or opted-out of installment payments, to manage underwriting of installment plans (e.g., as provided by the issuers 108a-c, etc.), and to interact with the user 112 (and other users) in connection with such plans (e.g., facilitating pre-approval (and actual approval) of the user 112 (and other users) in connection with providing an installment plan to the user 112 and confirming repayment thereof, etc.). For instance, in connection with identifying parties that have opted-in (or opted-out) of installment payments, the installment host 116 and/or the IPP 124 may be able to access or retrieve a listing of registered parties (e.g., merchants, etc.) via a merchant participation API, etc. Such identification may be based on a card product code and/or a country code (or other data indicative of a merchant), whereby one or more particular parties may then be identified.

Subsequently, in connection with an example transaction sequence, the user 112 accesses the e-commerce platform of the first party 102. In this embodiment, the e-commerce platform, and more broadly, the first party 102, includes the installment SDK 120 associated with the installment host 116. As the user 112 browses for products to purchase, the first party 102 is configured, by the SDK 120, to indicate installment availability to purchase certain ones, or all, of the products (based on the opt-in or opt-out parameters for the first parry 102, etc.). When the user 112 adds products to a shopping cart and proceeds to checkout, the first party 102 is configured, by the wallet SDK 122 (associated with a virtual wallet platform, etc.), to request a determination as to eligibility of the first party 102 for installment payments from the installment host 116, based on the first party 102 and/or transaction details for the transaction initiated by the user 112. In response, the installment host 116 is configured to determine the eligibility of the first party 102 and/or the transaction based on the installment parameters included in the database 118, and to revert with eligible installment types, if any, to the first party 102. The eligible installment types may include, for example, Pay-in-4 (e.g., buy now, pay later offering with standard four payment terms, etc.), installments flex (e.g., installment offering funded by consumers or co-funded by merchants with installment offer terms defined by the installment host, etc.), and extended tenure (e.g., installment offering funded by merchant with installment offer terms established in a bi-lateral agreement between the IPP 124, the installment host 116, and/or the first party/merchant 102, etc.), etc. When eligible, the first party 102 is configured, by the wallet SDK 122, to present the installment types to the user 112, potentially, along with one or more payment accounts previously provisioned to the virtual wallet and/or mobile device 110.

In turn, as part of checkout, the user 112 selects to pay with installments, and the first party 102 is configured, by the wallet SDK 122, via the installment SDK 120, to then request installment payment options from the installment host 116. The request includes the merchant identifying information (e.g., MAID, etc.), the transaction amount and currency, and payment terms, etc.

In particular in the above example transaction sequence, the installment host 116 is configured to determine installment plans based on certain rules associated with the eligibility parameters for the different issuers 108a-c. The rules are executed and/or determined, based on matching the user 112, for example, and the purchase to the appropriate pre-defined merchant, issuer, transaction, and/or consumer rules and/or parameters. In one or more embodiments, for example, the installment host 116 may be configured to determine a specific installment plan for a specific transaction from a general offer from one of the issuers 108a-c. For example, where an installment option includes four payments, the installment host 116 may be configured to calculate the four payments based on the transaction amount (including tax) and any applicable fees associated in the installment payment, etc. In this manner, the installment host 116 is configured to determine an installment option specific to the transaction to the first party 102. It should be appreciated that the installment host 116 may be configured to determine the specific installment option from various different available installment options from the same or different issuers 108a-c.

Next, the installment host 116 is configured to return the installment option(s) identified for the transaction to the first party 102, via the installment SDK 120.

The first party 102 is configured, by the installment SDK 120, to then present the installment options/offers to the user 112. When the user 112 selects one of the installment options, the first party 102 is configured, by the installment SDK 120, via the wallet SDK 122, to solicit a repayment account for the installments from the user 112. In connection therewith, the first party 102 (and/or mobile device 110) is configured, by the wallet SDK 122, to present the payment account provisioned to the wallet application 114 and/or another account option. For example, the user 112 may opt to select an account (e.g., bank account, etc.) associated with an ACH transaction. When the user 112 selects a payment account, the first party 102 is configured, by the wallet SDK 122, to provide an account number for the selected account to the installment SDK 120. The first party 102 is configured, by the installment SDK 120, to provide the account number, and other details, as desired/required, to the installment host 116. The installment host 116, in turn, is configured to store the account number in the database 118, for example, or to tokenize the account number (e.g., through interaction with the processing network 106, etc.) and to store the token, as a card-on-file payment for the installments indicated in the select installment plan. Additional details, such as, for example, installment amount, issuer of the installment option, etc., are also store in the database 118.

Thereafter, the installment host 116 is configured to coordinate a know-your-customer (KYC) sequence. In particular, in this example, the installment host 116 is configured to collect identifying data for the user 112, via the installment SDK 120, as part of the installment selection (e.g., at checkout, etc.) or otherwise (e.g., later via the virtual wallet application 114 or another application at the mobile device 110, etc.). The installment host 116 is configured to then determine identifying data required for verifying the user 112, from at least one identity provider (not shown). The installment host 116 is configured to solicit, via the installment SDK 120, the identity data from the user 112. Or, alternatively, the first party 102 is configured, by the installment SDK 120, to solicit the identifying data (e.g., in a form, sequence of queries, etc.) from the user 112, whereby the user 112 provides the identifying data. In the later, the first party 102 is configured, by the installment SDK 120, to provide the identifying data back to the installment host 116.

In turn, the installment host 116 is configured to submit the identifying data to the identity provider, via an API associated therewith, whereupon the identity provider is configured to verify the identifying data. This may include, for example, submitting the identifying data, a summary thereof or a score related thereto, to an underwriting service associated with the issuer 108a (e.g., the IPP 124 or other service, etc.), which is associated with the offered/selected installment option. The installment host 116 is configured to receive a result from the identity provider (via the API), and to provide the result to the user 112, via the installment SDK 120, etc. It should be appreciated that, alternatively, the installment SDK 120 may configure the first party 102, for example, to interact directly with the identity provider, whereby a session between the user 112 and the identity provider is initiated, which may permit more limited identifying data to be captured by the installment SDK 120 and/or the first party 102.

While the KYC sequence is included in this system embodiment, it should be appreciated that the KYC sequence may be omitted from other system embodiments, and/or for certain types of accounts/transactions. For example, where the account designated to pay the installments is a bank account, through which ACH transactions are initiated, the KYC sequence may be omitted. Likewise, for small value transactions, the KYC sequence may be omitted.

Next in this example embodiment, the first party 102 is configured, by the installment SDK 120, to create the installment plan based on the selected option. In response, the installment host 116 is configured to create the installment plan with the account designated by the user 112. In doing so, the installment host 116 may be configured to use a payment account credential (e.g., PAN, etc.) provided by the user 112, as a real-card-number (RCN). Alternatively, the installment host 116 may be configured to request a virtual card number (VCN) from a VCN provider (not shown), whereupon a VCN is generated and provided (along with a limit on the VCN). The limit may be predetermined by the IPP 124, for example, as part of the eligibility rules for the installment option, etc. The installment plan is created with the RCN or the VCN (as a record of the agreement to the installment terms (e.g., payment terms, amount, payment account credential for repayment, etc.)), and stored in the installment database 118. And, the installment host 116 is configured to indicate the successful installment plan to the user 112, via the installment SDK 120.

When the installment plan is created, and stored, the installment host 116 is configured to indicate the success to the first party 102. In turn, the first party 102 is configured to complete the checkout of the user 112 for the product(s) purchase, and to initiate a transaction for the amount of the purchase, using the RCN or associated token, or the VCN.

Further, at a later time, as defined by the installment plan, an installment payment is initiated. In particular, in this embodiment, the installment host 116 and/or the IPP 124 is configured to request payment, via the processing network 106. The processing network 106 is configured, in response, to initiate a payment transaction from the user's selected account to the issuer 108a, for example, associated with the select installment option. When the transaction is successful, the installment host 116 and/or the IPP 124 is configured to update the installment plan in the database 118 to indicate the installment payment, as defined by the installment plan, is complete. If the transaction is not successful, the installment host 116 and/or the IPP 124 may be configured to retry the transaction after a wait interval. The installment payments are repeated, by the installment host 116 and/or the IPP 124, as needed, until the repayment obligation of the user 112, as defined in the installment plan, is complete.

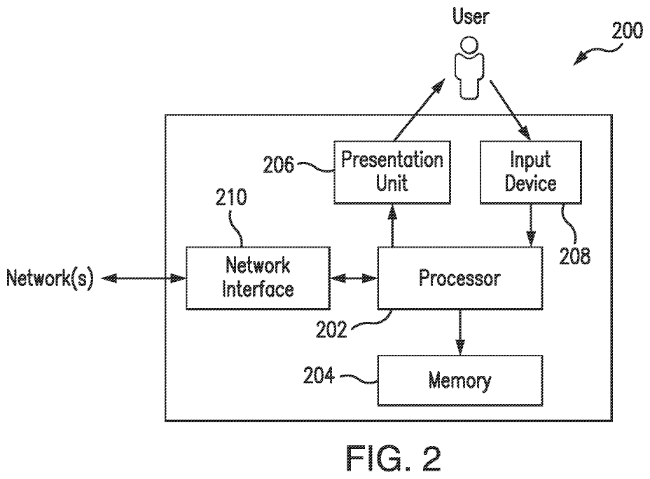

FIG. 2 illustrates an example computing device 200 that may be used in the system 100. The computing device 200 may include, for example, one or more servers, workstations, personal computers, laptops, tablets, smartphones, PDAs, terminals, virtual machines, etc. In addition, the computing device 200 may include a single computing device, or it may include multiple computing devices located in close proximity or distributed over a geographic region, so long as the computing devices are specifically configured to function as described herein. In the system 100 of FIG. 1, each of the first party 102, the acquirer 104, the processing network 106, the issuers 108a-c, the mobile device 110, the installment host 116, the IPP 124, etc. may include or may be implemented in a computing device (or multiple computing devices) consistent with computing device 200 coupled to (and in communication with) one or more networks. That said, the system 100, or parts thereof, should not be understood to be limited to the computing device 200, as other computing devices may be employed in other system embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, transaction data, eligibility parameters, installment parameters, identifying data, rules, and/or other types of data (and/or data structures) as needed and/or suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special purpose computing device. It should be appreciated that the memory 204 may include a variety of different memories, each implemented in one or more of the operations or processes described herein.

In the example embodiment, the computing device 200 includes a presentation unit 206 that is coupled to (and that is in communication with) the processor 202 (however, it should be appreciated that the computing device 200 could include output devices other than the presentation unit 206, etc.). The presentation unit 206 outputs information (e.g., installment options, etc.), either visually or audibly, to a user of the computing device 200, for example, the user 112 in the system 100, etc. In connection therewith, various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user (i.e., user inputs) such as, for example, selections of installment options, payment accounts, etc. by user 112, or inputs from other computing devices. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network(s) of the system 100. Further, in some example embodiments, the computing device 200 may include the processor 202 and one or more network interfaces incorporated into or with the processor 202.

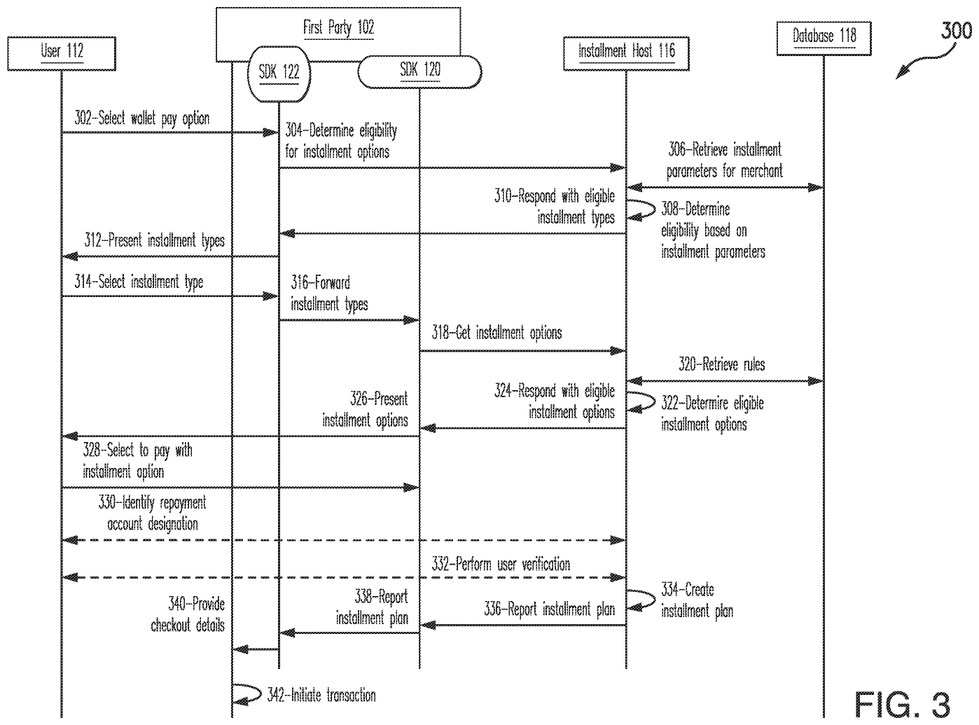

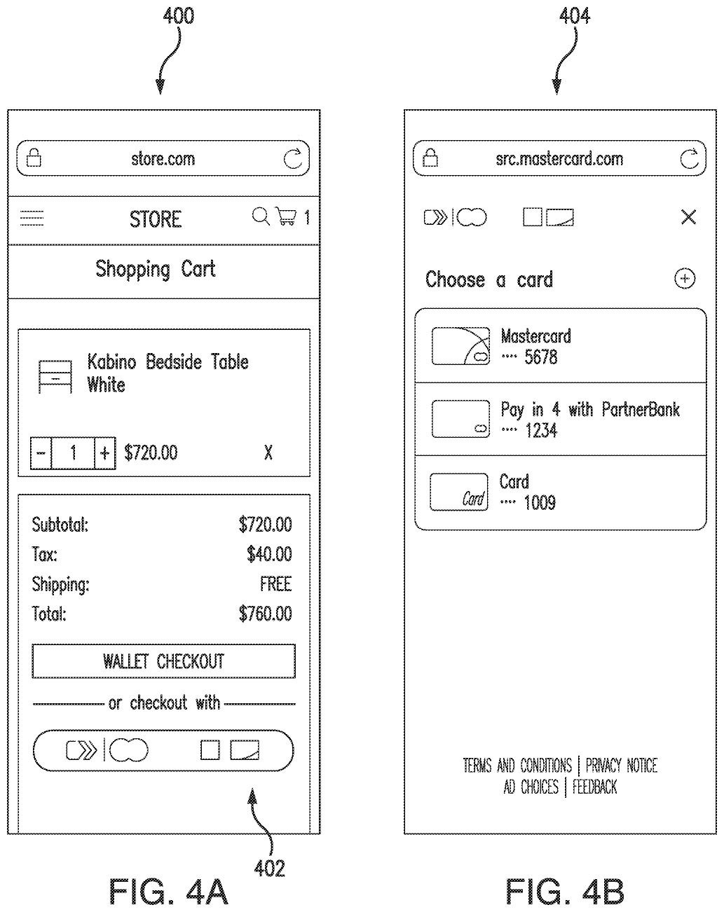

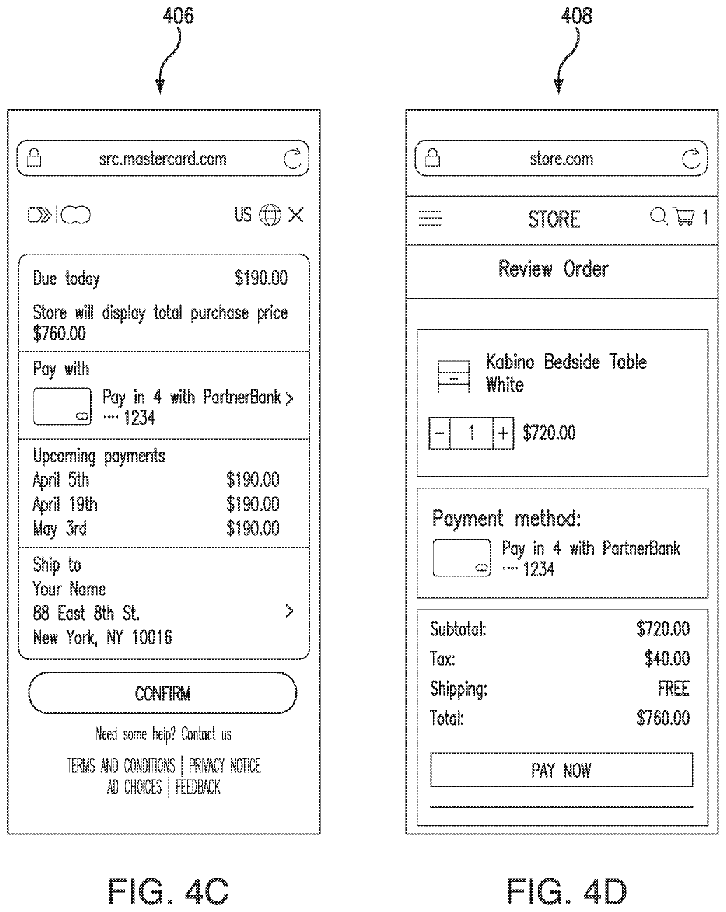

FIG. 3 illustrates an example method 300, for use in providing a user with installment options at a virtual location, in connection with the user initiating a purchase of a product through the virtual location. The example method 300 is described as implemented in the installment host 116, and the system 100, more generally. Additional reference is also made to the computing device 200 and the example interfaces shown in FIGS. 4A-4D. Nonetheless, it should be understood that the methods herein are not limited to the system 100 and/or the computing device 200 and/or the interfaces of FIGS. 4A-4D. Likewise, the systems, devices, and interfaces herein should not be understood to be limited to the method 300.

At the outset, it should be appreciated that the database 118 includes the MAID for the first party 102, along with the installment and eligibility parameters for the first party 102 and the issuers 108a-c.

When the user 112 decides to purchase a product at the first party 102, the user 112 selects the product in a website (broadly, a virtual location of the first party 102), for example, associated with the first party 102 and adds the product to purchase (e.g., adds the product to a virtual shopping cart, etc.). When the user 112 proceeds to checkout, or purchases the product, the website provides different options for payment. The different options may include, for example, a debit card, a credit card, fund transfers (e.g., PayPal®, Zelle® service, etc.), and also a wallet pay option (for the user's virtual wallet, etc.). An example wallet pay option that may be presented to the user 112 at the mobile device 110, for example, is illustrated in the interface 400 of FIG. 4A, at 402. In this example embodiment, the user 112, selects, at 302, the wallet pay option.

In response, the wallet SDK 122 included in the website retrieves wallet data for the user 112 (e.g., after an authentication or login, etc.). In addition, the wallet SDK 122 determines, at 304, if eligibility for installment payments exist for the given transaction. In connection therewith, the MAID for the first party 102 is transmitted with the request, to the installment host 116. In turn, the installment host 116 retrieves, at 306, the installment parameters for the first party 102, based on the MAID. As described above, the installment parameters indicate whether the first party 102 has opted into or out of installment payments, and potentially, the specific types of installments that the first party 102 has opted in for, if any.

The installment host 116 then determines, at 308, eligibility based on the installment parameters for the first party 102, and responds, at 310, to the wallet SDK 122, with the eligibility indication and with available installment types for the first party 102, as appropriate (e.g., based on a merchant participation API, etc.). Upon receipt, the wallet SDK 122, as part of the first party website, presents, at 312, the installment types to the user 112. In connection therewith, the mobile device 110 may display the interface 404 of FIG. 4B to the user 112, for example, via the user's wallet application 114. In doing so, in this example, the interface 404 includes three options for funding the transaction of which one is a “Pay in 4” type installment payment directed to a pre-approved, user specific account (e.g., an account ending in 1234, etc.). The user 112, in this example, selects, at 314, to proceed with the installment type (e.g., the “Pay in 4” installment payment type in FIG. 4B, etc.). That said, while the account to be used in the installment payment is shown as stored in the user's wallet application 114, for example, this is not required in all embodiments. For instance, in some embodiments, a credential for the account used to fund the identified installment payment may be provided by the IPP 124 during checkout to the wallet application 114 for presentation to the first party 102, etc.

In turn, the wallet SDK 122 forwards, at 316, to the installment SDK 120, the selection of the installment type. The installment SDK 120 then gets, at 318, the corresponding installment option, consistent with the selected installment type, from the installment host 116. The installment host 116 retrieves, at 320, rules consistent with the transaction (e.g., rules on amount, rules on MCC, etc.). Thereafter, the installment host 116 determines, at 322, eligible installment options for the transaction. In general, the issuers 108a-c provide the installment options based on various details of the transaction, including, amount limits, MCC, specific merchants, times/dates, etc. The installment options may be generic to the specific detail of the transaction, whereby the installment host 116 determines the installment option for the specific transaction. For example, where the issuer 108c provides a general option for Pay in 4 over six weeks, with a limit of $1000 for MCC 5712 (Furniture, Home Furnishings, and Equipment Stores, Except Appliances), the installment host 116 determines the option is consistent with the transaction, and further determines that the pay in 4 would be an equal payment of $190, with the first payment due immediately and the next three payments due in two week intervals (e.g., today, April 5, April 19, May 5, etc.).

It should be appreciated that the installment host 116 may determine, at 322, that the transaction is eligible for one or multiple installment options, whereby the installment host 116 determines (or identifies) multiple available installment options.

At 324, the installment host 116 responds with the eligible installment option(s) and, at 326, the installment SDK 120 included in the website of the first party 102 presents the installment option(s) to the user 112. In connection therewith, the user 112 may be presented, at the mobile device 110, with interface 406 of FIG. 4C, for example, which illustrates the “Pay in 4” type installment option for the purchase and includes the specific amounts to be paid on the specific dates, as determined by the installment host 116.

The user 112 then selects to pay with the installment option, at 328, whereupon the installment SDK 120 and the installment host 116 are notified on the selection. For example, in connection with the mobile device 110 displaying the interface 406 of FIG. 4C to the user 112, the user 112 may confirm the detail of the installment plan via the interface. In response, the mobile device 110 may display interface 408 of FIG. 4D to the user 112 through which the user 112 may select to pay with the installment plan. Then in the method 300, the user 112 and the SDK installment host 116 cooperate, through the installment SDK 120, as indicated by the dotted line, to identify, at 330, a repayment account for the installment option. For example, the user 112 may enter a payment account number into an interface (e.g., a credit card, a debit account, a bank account, etc.), or select a payment account provisioned to the wallet profile of the user 112 (e.g., in the virtual wallet, etc.). The credential for the identified/selected repaying payment account (e.g., PAN, token, etc.) is stored in the installment host 116 and/or the database 118.

Further, the user 112 and the installment host 116 may cooperate, via the installment SDK 120 (optionally, as indicated by the dotted line), to perform user verification, at 332, through which identifying data about the user 112 is verified. As the installment options provided by the issuers 108a-c are forms of credit, or loans, the issuers 108a-c may require a threshold amount of verification of the user's identifying data. In connection therewith (and in connection with the given installment option selected by the user 112), the installment host 116 solicits identifying data and verifies the same with an identity provider. The installment host 116 may inform the issuer 108c, for example, associated with the selected installment option, of the status of the verification and/or the results of the verification (e.g., scoring, etc.).

Thereafter, the installment host 116 creates, at 334, an installment plan as defined in (or by) the selected installment option and which includes the identifying data of the user, in whole or in part, and the payment credential for the repayment account. The installment plan includes the payment terms, the amount, and the payment account credential for repayment, and/or other suitable data. And, the installment plan is stored, by the installment host 116, in the database 118. At 336, the installment host 116 reports the installment plan to the installment SDK 120, which reports the same to the wallet SDK 122, at 338. At 340, the wallet SDK 122 provides the payment details/credentials for the account to fund the transaction to the first party 102 (from the installment plan). And, the first party 102 initiates, at 342, a transaction for the full amount of the product (in accordance with the installment plan). In connection therewith, the issuer associated with the given installment plan may provide a payment credential for funding a full amount of the interaction to the IPP 124 and then to the installment host 116. In turn, in this example, the installment host 116 may provide the payment credential to the wallet application 114 (at the mobile device 110). In this manner, the first party 102 is paid in full for the checkout transaction during checkout. Separately, the IPP 124 may provide a repayment credential for the user 112, or may rely on the installments host 116 to collect it as an on-behalf-of operation. That said, the IPP 124 may approve the installment loan, and use the repayment credential for the loan repayment by the user 112.

In view of the above, the systems and methods herein extend installment options to users, from various providers, at virtual merchant locations through which the users purchase products. As part of checking out, then, the installment host and/or IPP coordinate and offer installment options to the users (e.g., via wallet functionality, etc.), and further coordinate acceptance of the installment options and execution of the selected installment plans. In this way, the consumers are provided a convenient way to utilize installment payments to purchase products through their conventional checkout at the merchants. What's more, the integration of such installment options through the users' digital wallets provides a simplified manner for the users to complete digital payment transactions, while also making use of installment payment options.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims, including, for example: (a) receiving a first request for an installment payment, from a user, via a wallet software development kit (SDK) at a first party, wherein the installment payment is for a transaction between the user and the first party, the first request including identifying information for the first party; (b) determining an eligibility of the first party for the installment payment based on the identifying information for the first party and at least one installment parameter defined by the first party; (c) responding to the first request, with one or more eligible installment types; (d) receiving a second request, via an installment SDK at the first party, for installment options consistent with a selected one of the one or more eligible installment types; (e) determining, based on one or more rules, at least one installment option for the transaction; (f) responding to the second request, with the at least one installment option; (g) in response to a selection of the at least one installment option by the user, creating an installment plan for the at least one installment option and storing the installment plan in a memory, the installment plan including a payment account credential for a repayment account for the instalment plan; (h) soliciting the payment account credential from the user, via the installment SDK; (i) receiving the payment account credential, from the user, via the installment SDK, prior to creating the installment plan; (j) initiating at least one payment account transaction based on the payment account credential consistent with the installment plan; and/or (k) providing a second payment account credential to a wallet application of the user for funding a full amount of the transaction between the user and the first party, the second payment account credential different from the payment account credential of the installment plan.

With that said, example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” “associated with,” or “in communication with” another feature, element or layer, it may be directly on, engaged, connected, coupled, associated, or in communication with/to the other feature, element or layer, or intervening features, elements or layers may be present. In contrast, when feature, element or layer is referred to as being “directly on,” “directly engaged to,” “directly connected to,” “directly coupled to,” “directly associated with,” or “directly in communication with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the example embodiments.

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A non-transitory computer-readable storage medium comprising executable instructions, which when executed by at least one processor, cause the at least one processor to:
receive a first request for an action, from a user, via a first software development kit (SDK) at a first party, wherein the action is between the user and the first party, the first request including identifying information for the first party;
determine an eligibility of the first party for the action based on the identifying information for the first party and at least one parameter defined by the first party;
respond to the first request with one or more eligibility types;
receive a second request, via a second SDK at the first party, for multiple options consistent with a selected one of the one or more eligibility types;
determine, based on one or more rules, at least one of the multiple options;
respond to the second request with the at least one of the multiple options; and
in response to a selection of one of the at least one of the multiple options by the user, create a plan consistent with the one of at least one of the multiple options and store the plan in a memory, the plan including an account credential for an account associated with the plan.

2. The non-transitory computer-readable storage medium of claim 1, wherein the executable instructions, when executed by the at least one processor, further cause the at least one processor to:
solicit the account credential from the user, via the SDK; and
receive the account credential, from the user, via the SDK, prior to creating the plan.

3. The non-transitory computer-readable storage medium of claim 1, wherein the action includes an installment payment; and
wherein the plan includes an installment plan; and
wherein the account credential includes a payment account credential.

4. The non-transitory computer-readable storage medium of claim 3, wherein the options includes installment options; and
wherein the identifying information for the first party includes a merchant acceptor ID (MAID) for the first party.

5. The non-transitory computer-readable storage medium of claim 4, wherein the executable instructions, when executed by the at least one processor, further cause the at least one processor to cause at least one payment account transaction, based on the payment account credential, consistent with the installment plan.

6. The non-transitory computer-readable storage medium of claim 1, wherein the first SDK and the second SDK are integrated into a single SDK.

7. A computer-implemented method for use in extending installment options to users, the method comprising:
receiving a first request for an installment payment, from a user, via a wallet software development kit (SDK) at a first party, wherein the installment payment is for a transaction between the user and the first party, the first request including identifying information for the first party;
determining, by a computing device, an eligibility of the first party for the installment payment based on the identifying information for the first party and at least one installment parameter defined by the first party;
responding, by the computing device, to the first request, with one or more eligible installment types;
receiving a second request, via an installment SDK at the first party, for installment options consistent with a selected one of the one or more eligible installment types;
determining, by the computing device, based on one or more rules, at least one installment option for the transaction;
responding, by the computing device, to the second request, with the at least one installment option; and
in response to a selection of the at least one installment option by the user, creating, by the computing device, an installment plan for the at least one installment option and storing the installment plan in a memory, the installment plan including a payment account credential for a repayment account for the instalment plan.

8. The computer-implemented method of claim 7, further comprising:
soliciting, by the computing device, the payment account credential from the user, via the installment SDK; and
receiving the payment account credential, from the user, via the installment SDK, prior to creating the installment plan.

9. The computer-implemented method of claim 8, wherein the wallet SDK and the installment SDK are the same SDK.

10. The computer-implemented method of claim 7, further comprising initiating, by the computing device, at least one payment account transaction based on the payment account credential consistent with the installment plan.

11. The computer-implemented method of claim 7, further comprising providing a second payment account credential to a wallet application of the user for funding a full amount of the transaction between the user and the first party, the second payment account credential different from the payment account credential of the installment plan.

12. The computer-implemented method of claim 7, wherein the identifying information for the first party includes a merchant acceptor ID (MAID) for the first party.

13. A system for use in extending installment options to users, the system comprising at least one computing device configured to:
receive a first request for an installment payment, from a user, via a wallet software development kit (SDK) at a first party, wherein the installment payment is for a transaction between the user and the first party, the first request including identifying information for the first party;
determine an eligibility of the first party for the installment payment based on the identifying information for the first party and at least one installment parameter defined by the first party;
respond to the first request, with one or more eligible installment types;
receive a second request, via an installment SDK at the first party, for installment options consistent with a selected one of the one or more eligible installment types;
determine, based on one or more rules, at least one installment option for the transaction;
respond to the second request, with the at least one installment option; and
in response to a selection of the at least one installment option by the user, create an installment plan for the at least one installment option and storing the installment plan in a memory, the installment plan including a payment account credential for a repayment account for the instalment plan.

14. The system of claim 13, wherein the at least one computing device is further configured to:
solicit the payment account credential from the user, via the installment SDK; and
receive the payment account credential, from the user, via the installment SDK, prior to creating the installment plan.

15. The system of claim 14, wherein the at least one computing device is further configured to initiate at least one payment account transaction based on the payment account credential consistent with the installment plan.

16. The system of claim 13, wherein the at least one computing device is further configured to initiate at least one payment account transaction based on the payment account credential consistent with the installment plan.

17. The system of claim 13, wherein the at least one computing device is further configured, prior to receipt of the first request, to provide a second payment account credential to a wallet application of the user for use in funding a full amount of the transaction between the user and the first party, the second payment account credential different from the payment account credential of the installment plan.

18. The system of claim 13, wherein the identifying information for the first party includes a merchant acceptor ID (MAID) for the first party.
